(19) United States
(12) Patent Application Publication
(10) Pub. No.: US 2025/0293576 A1
(43) Pub. Date: Sep. 18, 2025

(54) ELECTRIC MOTOR WITH ELECTRICAL GENERATION CAPACITY

(71) Applicant: Adam Theuret, Orting, WA (US)

(72) Inventor: Adam Theuret, Orting, WA (US)

(21) Appl. No.: 19/087,139

(22) Filed: Mar. 21, 2025

Related U.S. Application Data
(60) Provisional application No. 63/569,665, filed on Mar. 25, 2024.

(51) Int. Cl. H02K 23/36

(52) U.S. Cl. CPC H02K 23/36

(57) ABSTRACT

An electric motor with shaft, rotor and stator. The stator has a pair of magnets amd the rotor has a number of rotor poles, and the same number of electrically isolated pole windings and inter-pole spaces. The motor has first and second commutators, each divided into equally arc spaced commutator segments, the same number as the number of rotor poles.

Each winding begins at a segment of the first commutator, passes through a first inter-pole space and back through an inter-pole space two spaces counterclockwise of the first space to complete a first winding turn, and after pre-selected number of winding turns, passes back through an inter-pole space three spaces counterclockwise of the first space for a second same number of winding turns as the first pre-selected number. The winding is completed at an segment of the second commutator arc-aligned at the same arc degree on the rotor shaft with the first commutator.

In the electric motor the two magnets are separate by a gap between them such that a line through the gap is 90 degrees out of alignment with a line between a pair of oppositely signed motor brushes.

The electric motor has two brush sets, with each of the two brush sets each having a pair of oppositely disposed brushes electrically isolated from each other and on opposite sides of the commutator.

A method for parallel simultaneous internal generation of an output current in a motor, while the motor is drawing current to spin a motor shaft is also presented.

### CROSS-REFERENCE TO RELATED APPLICATIONS

This application claims priority to U.S. Provisional Patent application 63/565,665 filed Mar. 25, 2024, which is hereby incorporated by this reference as if fully set forth herein.

### TECHNICAL FIELD

This disclosure relates to the field of electric motors and to electrical generation; more particularly it relates to an electric motor with parallel electrical generation capacity.

### BACKGROUND

Conventional DC electric motors require a current to create successive magnetic fields in the rotating rotor field windings and thereby induce a torque on the motor shaft and consequent rotary motion relative to the stator/rotor magnetic engagement in well-known fashion. Alternatively, it is a known variation to have the permanent magnets on a rotor with the field windings stationary and enclosing them.

In a conventional DC motor with the field windings on the rotor, windings are continuously wound upon respective rotor poles from a single length of wire which starts and ends on a conventional single commutator that is co-axial with the rotor shaft. Conventionally, each winding is electrically accessed at separate and discreet commutator segment pairs, one pair for each pole, and the motor operates within conventional degrees of lost efficiency because there are separate, polar currents moving in opposition within the windings (among others, conventional back-EMF).

Conventional electric motors have parts and potential characteristics of both a motor and a generator. That is, with an input of current to its field coils, the motor will run in a motor mode, spinning a motor shaft. When there is no current input to the field coils, the rotor and shaft may be mechanically spun or driven to move field coils through the fields of the stator magnets, to induce and produce a current output.

Conventional rotary switching schemes for motors and generators alike rely on dividing the rotation of the shaft (and rotors) into arc fractions of shaft rotation, and/or on dividing time on (current) from time off (no current). Whether expressed as arc fractions or time periods, conventional ratios for On and Off periods or arc fractions are in the range of unity or greater. That is, it is known to provide a rotary switching scheme where any particular field coil is On for the same period or fraction of rotation that it is Off—i.e. an on/off ratio of 1:1. It is even more common to provide a rotary switching scheme where any particular field coil is On for a much longer period or fraction of rotation than it is Off, for an on/off ratio greater than 1:1 (for example 2:1 or even 3:1).

What is needed is an electric motor that provides for internal and parallel generation of current in Current Off period windings of the motor, while the motor is drawing current to power successive Current On windings.

### SUMMARY OF THE INVENTION

New structural features for an electrical motor are disclosed for effecting a novel electric motor that provides for internal and parallel generation of current in Current Off period windings of the motor, while the motor is drawing current to power successive Current On windings.

In one example with a five pole rotor, each of the five electrically independent and isolated V-shaped field windings (also referred to herein as “V coils”) serially or sequentially receives a Current On for each rotation of the rotor shaft.

The portion of rotor rotation during which any one V coil has an input of current is thus roughly 20% of shaft rotation, leaving roughly 80% of shaft rotation when that V coil is not powered from input current. Instead that unpowered V coil is, for roughly 80% of its shaft rotation, under the current inducing influence of the magnetic fields of the stator.

The V coils are wound in a unique “V”-shaped fashion, so named “V” because a schematic cross-sectional view through the rotor and a single V coil appears as a V shape (or inverted or sideways V, depending upon the rotational position of the rotor seen in section).

For each V coil, a winding wire starts at a segment of a first commutator and ends at a paired and aligned segment on a second commutator, the two commutators engaged upon the rotor shaft at two opposite ends of the rotor. Each V winding is wound, not conventionally around any single pole, but from a particular Start segment of the first commutator and into a first inter-pole space A. (In a five pole rotor there are five inter-pole spaces, the spaces between the poles, each denoted respectively herein for illustration sake and ease of description as A, B, C, D and E.) The wire passes into and through a first inter-pole space called A and then around the other end of the pole and comes back, not conventionally through an adjacent space, but back through a space that is two spaces counterclockwise (where clock direction is taken as looking at the rotor end-on from the end closest to the first commutator).

This second space is called B. The wire passes back through to the end of space B and then once again into inter-pole space A. Windings proceed thus from this first winding through a total of “n” (for example, “n” may be 27) windings between space A and space B. Then on the nth winding, the wire goes again to space A, but this time comes back through a space three spaces clockwise (in this example five pole rotor) from space A. This is winding space C, and an additional substantially “n” windings then go through A and back through C until the nth winding ends by passing through space A to finish at the second commutator segment paired with and aligned with the Start segment on the first commutator.

This completes the first V winding, or V coil, also somtimes referred to herein as rotor coil 1. A second winding, or V Coil 2 is wound in the same V fashion, but with the rotor rotated one position counter-clockwise from space C so that space D is now in the position formerly occupied by space A, diagrammatically speaking.

The winding wire for coil 2 starts at a second commutator segment adjacent to that allotted to the first V coil and is then fed down space D to come back through openings E and B “n” times each respectively (in like manner as with A, B and C). The winding wire end is then connected to a second commutator segment paired with the segment on which V coil 2 started, in like manner as with V coil 1 and the first pair of commutator segments.

Continuing in like manner, Coil 3 uses spaces C, A and E, Coil 4 uses B, D and A and coil 5 uses E, C and D. All five coils are advantageously identical in winding and each in its own electrically isolated V shape. Because of the overlap of coils in the winding process, each V coil has substantially 2n windings.

It is desirable that all five coils (again, where the rotor has five poles; as other embodiments may have fewer or more poles) be wound simultaneously (rather than separately as it might appear from a literal reading of the above description). For example, in coil 1 first down through space A, while for coil 2 first down through space D, while for coil 3 first down through space C, while for coil 4 first down through space B and for coil 5 first down through space E. Thereafter every coil winding progresses in winding together and continues in five wires, for the example five pole rotor, being wrapped simultaneously so that each wrap of each coil is more or less equally layered throughout the windings.

### DETAILED DESCRIPTION

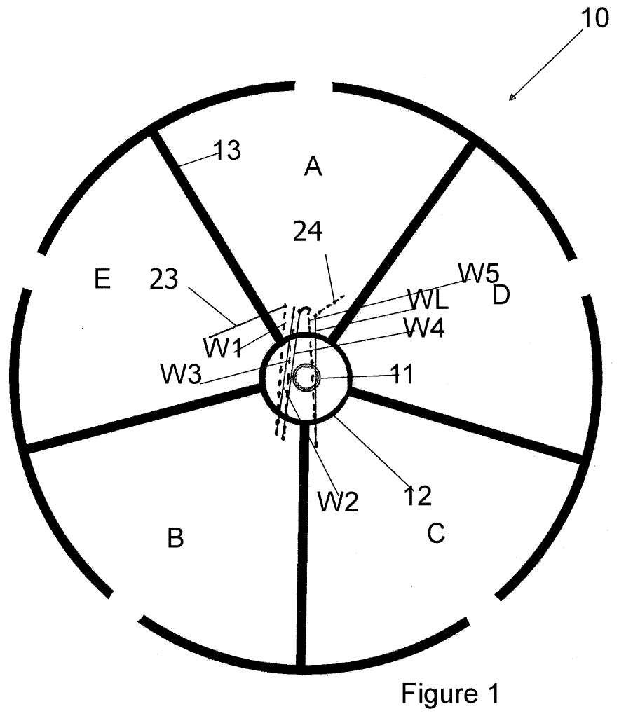

FIG. 1 is a schematic perpendicular cross-section of rotor 10 showing rotor shaft 11, rotor core 12 and five rotor poles 13. The inter-pole spaces A D C B E are notated in clockwise order from the top of the figure. An example field wire, notated in segments (labeled and discussed separately, although in practice, these segments are all part of a single winding wire) from W1 to W-L is illustrated. (And it is to be understood that the convention in this application for illustrating the winding of field wire W1 to W-L in the drawings is that solid lines are in front of the page or going into the page, the page being the plane of the cross-section of rotor 10, and dotted lines are behind the page or coming back out of the page.)

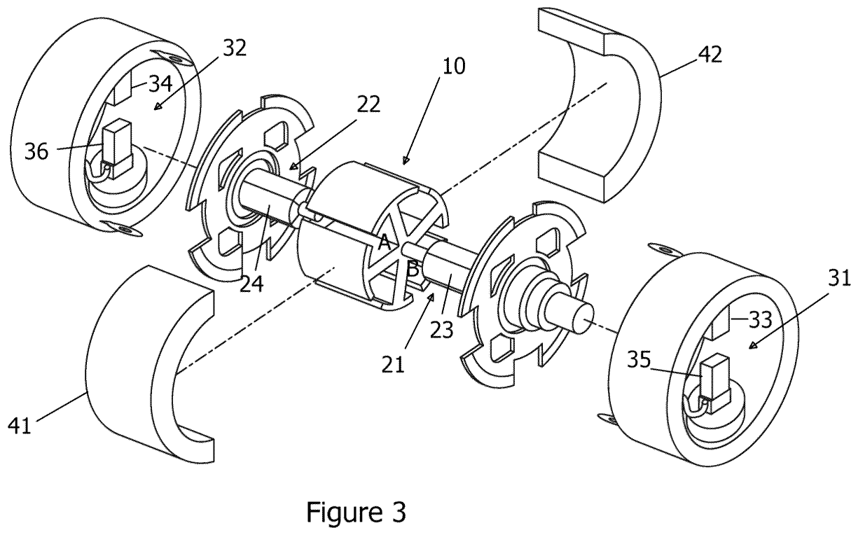

Continuous field winding wire W1 to W-L starts at a front commutator segment 23 (see also FIG. 3). From there it goes into inter-pole space A (in and behind the page) along W1 to inter-pole space B and out to the front of the page along W2 into inter-pole space A again. Successive continuing windings proceed thus through n windings (again, letting n be 27), so W3, typical of windings from first to n−1, returns from A to B) between space A and space B. Then on the nth winding, the wire goes again to space A along W4, but this time goes into the page along W5 and down to space C, and an additional substantially n windings then go between A and C (in fashion like to the n windings between A and B) until at the second nth winding, W-L comes out of the page and then once more into space A behind the page to finish at the respective paired and aligned rear commutator segment 24.

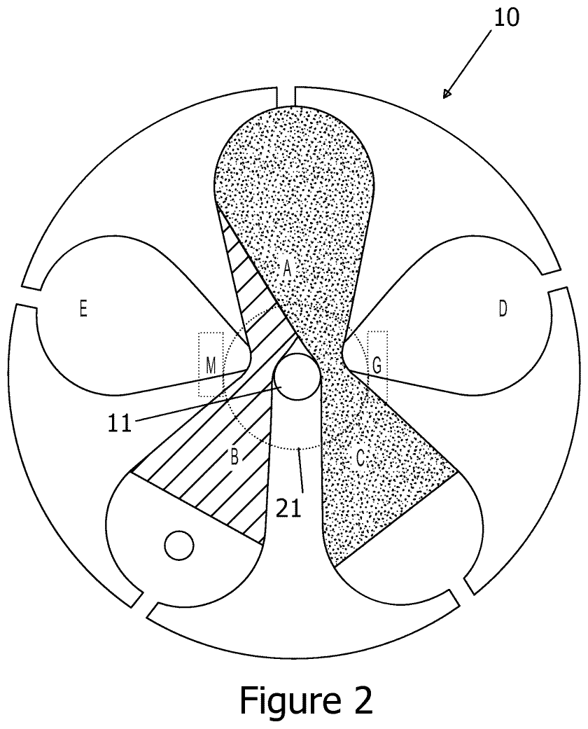

FIG. 2 illustrates an example placement, shape and installation of V Coil BAC (coil BAC seen in cross-section as triangle “BAC” and, in this position, as an inverted “V”). M and G are schematic representations only (see also FIG. 3) of a first set 31 of commutator brushes 33, 35 (M and G here drawn in dotted line only, to show position relative to circumference of commutator 21) and they are of polarity opposite to each other (i.e. M+ and G−). A second pair 32 of M and G brushes 34, 36 (not shown in FIG. 2) is in back of the plane of the figure section and interengaged with second commutator 22. The second brush pair 32 is substantially aligned with first brush pair 31, but of opposite polarity to the first pair (i.e. M34− and G36+).

Not shown in this figure is the desirable placement of permanent stator magnets 41, 42. The N magnet arc is substantially centered over coil BAC (inverted “V”); the S magnet is substantially 180 degrees below the N magnet.

M and G in FIG. 2 are first commutator brush set 31. Second set 32 comprising M 34 and G 36 are at the other end of the shaft and substantially aligned to make contact with second commutator 22 at the other end of the shaft (see FIG. 3). The two M brushes (front and back, relatively) are the +and-terminals (in this example) for the drive side (current on) electrical connection to each isolated winding (powering the motor) and the two G brushes are the output (generator, or induced current) terminals. The two G brushes have polarity opposite to that of the M brushes (i.e. if the front M is + than the front G is-).

FIG. 3 is an exploded parts (selected parts) illustration of the interior of one example of the disclosed apparatus. Inter-pole spaces A and B are particularly called out for reference with the text above and to provide complementary context with the other drawing figures.

Coil BAC winding starts at commutator segment 23, schematically illustrated in respect to its position relative to coil BAC. Segment 23 is also schematically illustrated in the example as oriented to the M brush.

In operation, an “On” current flows from front M to back M (through a first coil connected to the respective commutator segments that are in contact with the brushes at the particular arc of rotor rotation) to energize the desired magnetic field in that coil. When the desired arc of rotation is completed (and the M brushes are now in contact with the next coil), the first coil becomes a coil moving in the magnetic field of the stator magnets for about 80% of its remaining rotation (for a five pole, five winding motor) per shaft revolution, and a charge is thereby induced in the coil which is released through the back and front G brushes to generate a desired output current.

For number of rotor poles=n, current On share of rotation is 1/n and the share of current Off is (n−1)/n. Thus the ratio of current On to current Off is:

$$\frac{1 / n}{1} / n - 1 / n$$

For examples, for n=5, the ratio is 1:4 and for n=9, the ratio is 1:8

Thus it can be seen that, for any particular electrically isolated V coil on the rotor, the alternating periods of current On and current Off in the coil are such that the period of current On is shorter than the period of current Off. In all cases contemplated by this disclosure, the ratio of the period of current On to the period of current Off is less than 1:1 (where evaluation of the expressions ‘more’ and ‘less’ with respect to comparative ratio expressions is a simple mathmatical comparison of one ratio expressed as a fraction to another ratio expressed as a fraction—i.e. “¼” or “ 1/9”).

By way of example and not limitation, contemplated ratios of the period of current On to the period of current Off are (1) less than or equal to 1:4; (2) less than or equal to 1:6; (3) less than or equal to 1:8; and (4) less than or equal to 1:10.

Stator magnet pairs are desirably curved to partially surround the rotor and these curved magnets are set so that the center of the magnet arcs are substantially on the top and bottom of the FIGS. 1 and 2 (not shown), so the gaps between the magnet arcs are substantially lined up with a line between commutator brushes “M” and “G” in FIG. 2. This orientation of commutator brushes to magnet position is substantially 90 degrees out of rotation with respect to conventional DC motor stator and brushes.

In disclosing a motor structure with rotating windings and stationary magnets, it is to be noted that persons of skill in the art will be able to employ the elements of this disclosure to a reverse rotor/stator topology as well. For example, with the magnets on the rotor and the the isolated field windings on the stator, the necessary circuitry and components would be within the knowledge of persons skilled in the art to make such a conversion of the disclosed technology.

The following examples are provided for further disclosure (and not by way of limitation to these examples).

An electric motor has a shaft, a rotor on the shaft and a stator. The stator includes at least one pair of magnets, for instance, a North magnet and a South magnet. The rotor has a number of rotor poles and the same number of electrically isolated pole windings and inter-pole spaces. The motor employs two commutators, with each commutator divided into the same number of substantially equally arc spaced commutator segments as there are rotor poles. Each winding begins at a segment of the first commutator, passes through a first inter-pole space and thence back through an inter-pole space two spaces counterclockwise of the first space to complete a first winding turn. Upon completing a pre-selected number of winding turns, it passes back through an inter-pole space three spaces counterclockwise of the first space for a second but substantially the same number of winding turns, to complete the winding at a segment of the second commutator. The two commutator segments are each arc-aligned at substantially the same arc degree on the rotor shaft.

It is to be noted that, where the term “substantial” or “substantially” is employed in this disclosure, the meaning is that “near” or “nearly so” in the sense that trivial variations in the value or measurement of the respective word or term modified by “substantial” or “substantially” are to be taken as disclosed equivalencies herein. “Trivial” and words of like connotation are used in the same sense as used by persons skilled in the art. For example, if an arc (or angle) measurement (in degrees) is varied by, say, five degrees, and this variance is generally regarded by persons skilled in the art as trivial, then the variance is intended herein to be encompassed by the term “substantial” or “substantially”.

The electric motor desirably has at least two brush sets, and each of the two brush sets are a pair of brushes electrically isolated from each other. The two brushes of each pair of brushes are disposed on opposite sides of the respective first and second commutators. Each commutator may be implemented in the form of any rotary switch mechanism, now known or later developed, and otherwise configured in accordance with this disclosure, such as will be appreciated by those skilled in the art.

Desirably, the two commutators are disposed on the shaft on opposite sides of the rotor, but they may also in selected instances be disposed on the same side of the rotor, as long as each pair of axially aligned commutator segments are electrically isolated from other segment pairs.

The North and South magnets are disposed within the motor with two gaps between them such that a line produced from one gap to the other is substantially 90 degrees out of alignment with a line produced between the substantially oppositely disposed two brushes of at least one of the brush sets.

A disclosed motor shaft advantageously has a rotor and first and second commutators disposed axially on the shaft, each commutator divided into a same number of equal arc segments, each segment of the first commutator substantially arc-aligned axially with a corresponding segment of the second commutator to form an electically isolated segment pair. Each segment pair is electrically isolated from other segment pairs, and electrically connected with each other through a rotor winding.

A method for parallel simultaneous internal generation of an output current in a motor is disclosed. Although the motor is drawing current to spin a motor shaft, the motor has a plurality of electrically isolated motor windings. The method may have any number of desirable steps, and includes (a) providing a current to one of the plurality of motor windings via one of the electrically isolated pair of commutator segments to effect a torque movement to the motor shaft; and (b) the movement of the shaft in turn moving, through the magnetic field of a plurality of motor stator magnets to induce a current, at least one other electrically isolated motor winding that is not receiving a current. A third step is allowing the induced current to be drawn off by connecting the isolated motor winding to different pair of electrically isolated commutator segments.

It is to be noted that the electric motor is disclosed in terms of having five rotor poles, pole windings and inter-pole spaces. Other configurations are contemplated, such as the number 7 or 9 etcetera, instead of the number 5. Also, the pre-selected number of windings is herein disclosed as advantageously 27 and as being the same number for each half of the V coil. It is only necessary that the number of windings in each half of the V coil be substantially the same. While an equal number is desirable in each V coil half, it will be appreciated that minor and insubstantial differences in windings number between V coil halves will not depart from the scope of this disclosure, even if the differences result in less than optimum performance.

It is also contemplated that the number 27 is optimized for rotors of a given size, and that larger rotors with larger cross-sectional inter-pole areas will be able to advantageously accomodate a larger number of windings if the winding wire remains the same diameter as for smaller rotors. Other numbers of windings other than 27 are contemplated.

### INDUSTRIAL APPLICABILITY

The disclosed apparati and their electrical generation capacities provide significantly greater efficiency in power usage than known motors, especially in battery linked systems. The available parallel electrical generation capacity is also unknown in units of this scale and type. Units can also be built in compact form and operated in locations not usually associated with conventional electric motors and especially not in large scale power generation.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. An electric motor having a shaft, a rotor on the shaft and a stator, the stator comprising at least one pair of magnets the at least one pair comprising a North magnet and a South magnet;
the rotor further comprising a plurality of rotor poles, and the same plurality of electrically isolated pole windings and inter-pole spaces;
first and second commutators, each commutator divided into the same plurality of equally arc spaced commutator segments;
wherein each winding begins at a segment of the first commutator, passes through a first inter-pole space and thence back through an inter-pole space two spaces counterclockwise of the first space to complete a first winding turn; and
upon completing a pre-selected plurality of winding turns, thence passes back through an inter-pole space three spaces counterclockwise of the first space for a second but substantially the same plurality of winding turns, to complete the winding at a segment of the second commutator, the respective first and second commutator segments each arc-aligned at the same arc degree on the rotor shaft.

2. The electric motor of claim 1 further comprising at least two brush sets, each of the two brush sets comprising a pair of brushes electrically isolated from each other and each pair of brushes interengaged upon opposite sides of respective first and second commutators.

3. The electric motor of claim 1, wherein the commutators are implemented in the form of any rotary switch mechanism, now known or later developed.

4. The electric motor of claim 1, wherein the two commutators are disposed on the shaft on opposite sides of the rotor.

5. The electric motor of claim 1, wherein the pair of axially aligned segments are electrically isolated from other segment pairs.

6. The electric motor of claim 2, wherein the North magnet and the South magnet are disposed within the motor with two gaps between them such that a line produced from one gap to the other is substantially 90 degrees out of alignment with a line produced between the oppositely disposed two brushes of at least one of the brush sets.

7. An electric motor comprising a North magnet stator and the South magnet stator, wherein the two magnets are disposed within the motor with two gaps between them such that a line produced from one gap to the other is substantially 90 degrees out of alignment with a line produced between a pair of oppositely disposed motor brushes.

8. An electrically isolated electric motor rotor pole winding on a rotor having a plurality of both rotor poles and inter-pole spaces, wherein the winding extends through a first inter-pole space and thence back through an inter-pole space that is two spaces counterclockwise of the first inter-pole space, and again into the first space, to complete a first winding turn and, upon completing a pre-selected plurality of winding turns, thence extending back through an inter-pole space that is three spaces counterclockwise of the first space and again back into the first space, to complete an additional number of winding turns that is substantially the same plurality of winding turns.

9. An electric motor comprising at least two brush sets, each of the two brush sets comprising a pair of oppositely disposed brushes electrically isolated from each other and each pair of brushes interengaged upon respective opposite sides of at least one commutator.

10. An electric motor shaft comprising a rotor and first and second commutators disposed axially on the shaft, each commutator divided into a same number of equal arc segments, each segment of the first commutator arc-aligned axially with a corresponding segment of the second commutator to form a segment pair.

11. The motor shaft of claim 10, wherein the two commutators are disposed on the shaft on opposite sides of the rotor.

12. The motor shaft of claim 10, wherein the pair of axially aligned segments are electrically isolated from other segment pairs and electrically connected with each other through a rotor winding.

13. The motor shaft of claim 10, wherein the commutators are implemented in the form of any rotary switch mechanism, now known or later developed.

14. A method for parallel simultaneous internal generation of an output current in a motor, while the motor is drawing current to spin a motor shaft, the motor further comprising a plurality of electrically isolated motor windings, the method comprising the following steps:
a. providing a current to one of the plurality of motor windings via one of the electically isolated pair of commutator segments to effect a torque movement to the motor shaft;
b. the movement of the shaft in turn moving, through the magnetic field of a plurality of motor stator magnets to induce a current, at least one other electrically isolated motor winding that is not receiving a current.

15. The method of claim 14 further comprising allowing the induced current to be drawn off by connecting the isolated motor winding to different pair of electrically isolated commutator segments.

16. The electric motor of claim 1 wherein the plurality of rotor poles, electrically isolated pole windings and inter-pole spaces is five; and the pre-selected number of windings is 27.

17. The electric motor of claim 1 wherein at least one commutator is present in the form of a rotary electrical switch selected from the group of rotary electrical switches consisting of commutator with brushes, optical commutator and absolute shaft position sensor with associated electronics.

18. The electric motor of claim 8 wherein the plurality of rotor poles, electrically isolated pole windings and inter-pole spaces is five; and the pre-selected number of windings is 27.
